(19) United States
(12) Patent Application Publication
(10) Pub. No.: US 2026/0149906 A1
(43) Pub. Date: May 28, 2026

(54) WATERPROOF VIBRATION TRANSDUCER MODULE

(71) Applicant: HOSIDEN CORPORATION, Osaka (JP)

(72) Inventors: Tsuyoshi BABA, Fukuoka (JP); Ryuji AWAMURA, Fukuoka (JP); Kensuke NAKANISHI, Fukuoka (JP)

(73) Assignee: HOSIDEN CORPORATION, Osaka (JP)

(21) Appl. No.: 19/402,292

(22) Filed: Nov. 26, 2025

(30) Foreign Application Priority Data
Nov. 28, 2024 (JP) 2024-207018

(51) Int. Cl. H04R 1/08; H04R 1/04; H04R 3/04

(52) U.S. Cl. CPC H04R 1/086; H04R 1/04; H04R 3/04; H04R 2430/01

(57) ABSTRACT

A waterproof vibration transducer module includes a substrate which includes a through hole, a protrusion portion provided on one surface so as to surround the through hole, and a vibration conversion die mounted on the other surface so as to close the through hole; a holder which includes a hole and a rib being on a position surrounding the hole; a barrier diaphragm which is on a position overlapping with the through hole and the hole when viewed in a stacking direction, is clamped by the protrusion portion and the rib, and vibrates in a space formed by the hole and the protrusion portion; a first case in which a sound hole is formed; and a second case which is combined with the first case. The substrate, the holder, and the barrier diaphragm are accommodated in an internal space formed by combining the first case and the second case.

### TECHNICAL FIELD

The present disclosure relates to a waterproof vibration transducer module.

### BACKGROUND ART

Japanese Patent Application Laid Open No. 2022-118886 (hereinafter, referred to as Patent Literature 1) discloses an example of a conventional waterproof vibration transducer module.

In the waterproof vibration transducer module of Patent Literature 1, a waterproof vibration diaphragm is adhesively fixed to a lower surface of a case.

When adhesively fixing a waterproof vibration diaphragm to a case as in Patent Literature 1, manufacturing variation is likely to occur due to overflow of adhesive or other reasons.

### SUMMARY OF THE INVENTION

An object of the present disclosure is to provide a waterproof vibration transducer module in which manufacturing variation is less likely to occur.

A waterproof vibration transducer module according to the present disclosure includes a substrate, a holder, a barrier diaphragm, a first case, and a second case.

The substrate includes a through hole, a protrusion portion provided on one surface so as to surround the through hole, and a vibration conversion die mounted on the other surface so as to close the through hole.

The holder includes a hole and a rib being on a position surrounding the hole.

The barrier diaphragm is on a position overlapping with the through hole and the hole when viewed in a stacking direction, is clamped by the protrusion portion and the rib, and vibrates in a space formed by the hole and the protrusion portion.

In the first case, a sound hole is formed.

The second case is combined with the first case.

The substrate, the holder, and the barrier diaphragm are accommodated in an internal space formed by combining the first case and the second case with each other, the internal space is partitioned into two spaces by the holder and the barrier diaphragm, and one of the two spaces on a second case side is sealed.

### EFFECTS OF THE INVENTION

According to the waterproof vibration transducer module of the present disclosure, manufacturing variation is less likely to occur.

### BRIEF DESCRIPTION OF THE DRAWINGS

FIG. 1 is a plan view illustrating a waterproof vibration transducer module according to a first embodiment.

FIG. 2 is a perspective view illustrating the waterproof vibration transducer module according to the first embodiment.

FIG. 3 is an exploded perspective view illustrating the waterproof vibration transducer module according to the first embodiment.

FIG. 4 is an exploded perspective view illustrating the waterproof vibration transducer module according to the first embodiment.

FIG. 5 is a sectional view taken along a C-C line in FIG. 1 illustrating the waterproof vibration transducer module according to the first embodiment.

### DETAILED DESCRIPTION

An embodiment according to the present disclosure will be described in detail below. Here, components having the mutually-same functions will be provided with the mutually-same reference characters and duplicate description thereof will be omitted.

### First Embodiment

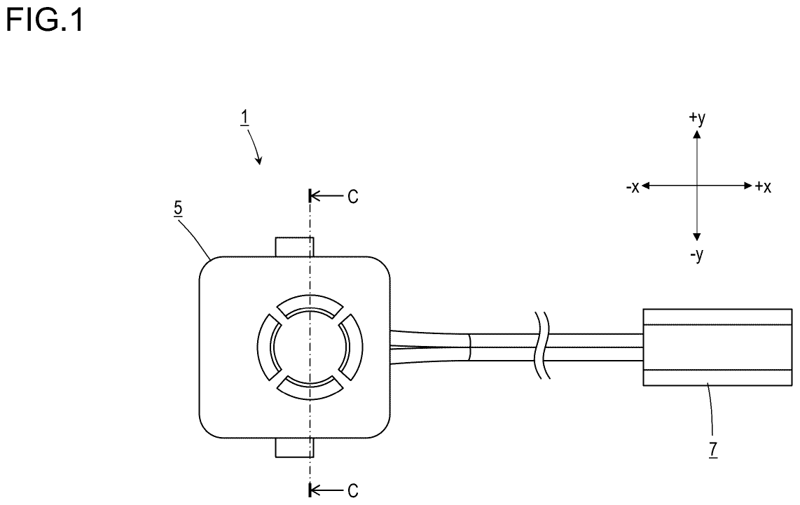

A structure of a waterproof vibration transducer module according to the first embodiment will be described below with reference to FIGS. 1 to 5.

A waterproof vibration transducer module 1 according to the present embodiment includes a substrate 2, a holder 3, a barrier diaphragm 4, a first case 5, a second case 6, and a connector 7.

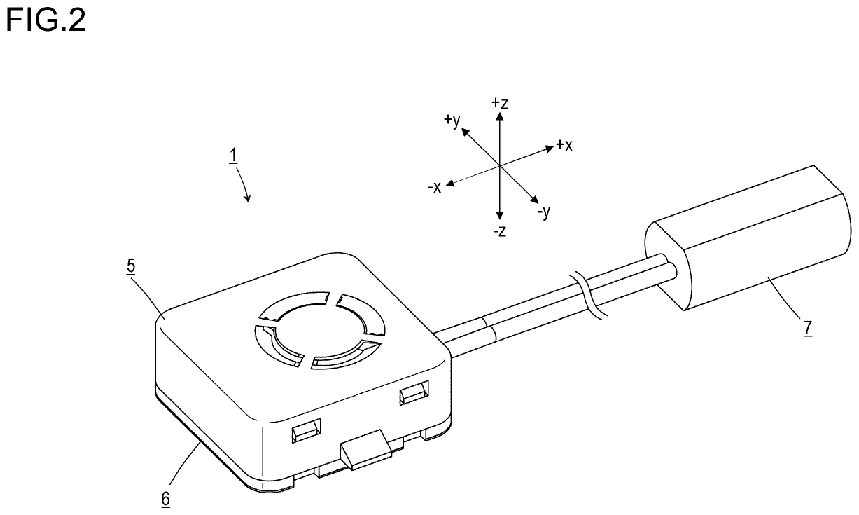

In FIGS. 1 to 5, x-axis, y-axis, and z-axis are defined to indicate directions. As illustrated in FIG. 1, a direction from the first case 5 toward the connector 7 is defined as a +x direction, and a direction opposite to the +x direction is defined as a −x direction. As illustrated in FIG. 2, a direction from the second case 6 toward the first case 5 is defined as a +z direction, and a direction opposite to the +z direction is defined as a −z direction. Directions orthogonal to the (+/−)x directions and the (+/−)z directions are defined as (+/−)y directions, where a left direction when facing the +x direction is defined as the +y direction, and a direction opposite to the +y direction is defined as the −y direction.

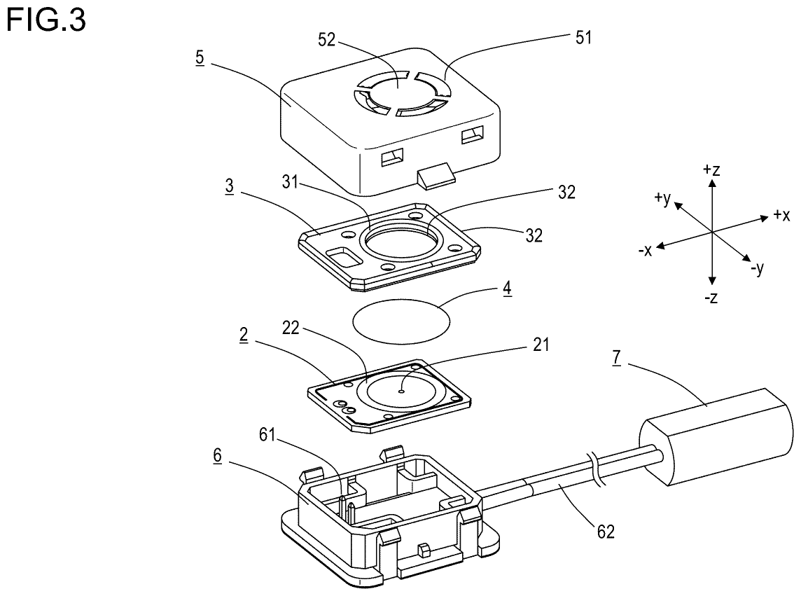

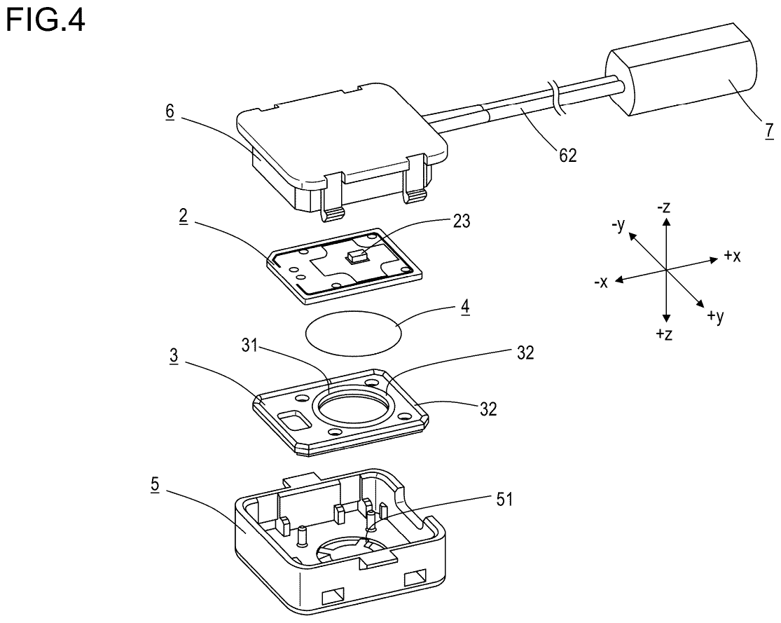

The substrate 2 includes a through hole 21 and a protrusion portion 22 as illustrated in FIG. 3, and includes a vibration conversion die 23 as illustrated in FIG. 4. The through hole 21 penetrates through the substrate 2. The protrusion portion 22 is provided on one surface (surface in the +z direction) of the substrate 2 so as to surround the through hole 21. The vibration conversion die 23 is mounted on the other surface (surface in the −z direction) so as to close the through hole 21. The substrate 2 may have, for example, a substantially-rectangular plate shape. The protrusion portion 22 may be formed in an annular shape so as to surround the through hole 21, as illustrated in FIG. 3. For example, it is more preferable that the protrusion portion 22 has an annular shape with an inner diameter of φ8 to 12 mm and a height of 0.02 to 0.08 mm.

Further, the substrate 2 may include a notch filter (not illustrated) which blocks a predetermined frequency of an output signal from the vibration conversion die 23 and an amplifier circuit (not illustrated) which adjusts a level of the output signal from the vibration conversion die 23. By correcting a peak in a frequency characteristic generated by an influence of the barrier diaphragm 4 with the notch filter, a flat frequency characteristic can be obtained across a wide band. This ensures a waterproofing property while enabling support for full-band (50 Hz to 16 kHz) which is a specification of CarPlay (registered trademark), for example.

As illustrated in FIG. 3, the holder 3 includes a hole 31 and a rib 32 which is on a position surrounding the hole 31. The hole 31 may have a circular shape. The hole 31 is preferably formed to have an inner diameter larger than the through hole 21.

The rib 32 may be provided not only on the position surrounding the hole 31 but also on end portions of the holder 3 in the +/−x directions and the +/−y directions and on both of one surface (surface in the +z direction) and the other surface (surface in the −z direction) of the holder 3, as illustrated in FIGS. 3 and 4. The rib 32 provided on the position surrounding the hole 31 contributes to fixation of the barrier diaphragm 4 and a sealing structure (airtight structure), and the ribs 32 provided on the end portions of the holder 3 contribute to the sealing structure (airtight structure).

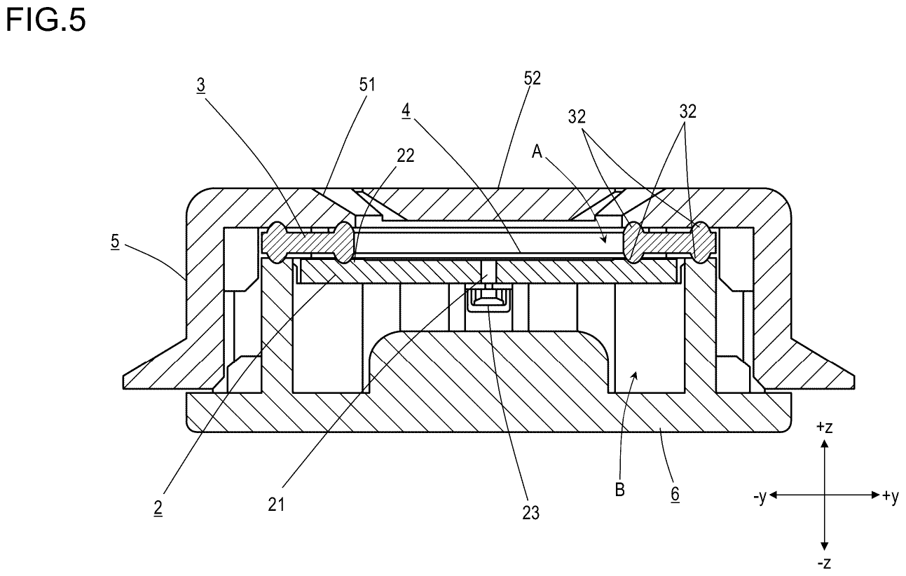

As illustrated in FIG. 5, the upper and lower ribs 32 on the outer side of the holder 3 (the ribs 32 positioned furthest on the +/−y sides) are clamped between the first case 5 and the second case 6 and their contact points are air-tightly sealed, preventing water from entering a space B in which the vibration conversion die 23 is arranged.

Further, the upper and lower ribs 32 on the inner side are clamped between the first case 5 and the barrier diaphragm 4 and their contact points are air-tightly sealed, preventing water from entering the space B in which the vibration conversion die 23 is arranged.

Accordingly, it is more preferable that the holder 3 (particularly the ribs 32) is an elastic body having appropriate hardness, because this enhances a sealing performance. For example, it is more preferable that the holder 3 is made of a material with a Shore hardness of D40 to D70.

As illustrated in FIG. 3, the barrier diaphragm 4 is on a position overlapping with the through hole 21 and the hole 31 when viewed in a stacking direction (z-axis direction). The barrier diaphragm 4 is clamped by the protrusion portion 22 and the rib 32 at its end portion and vibrates in the +z/−z directions in a space (gap) formed by the hole 31 and the protrusion portion 22.

The barrier diaphragm 4 can be made of, for example, SUS material. Further, it is more preferable that the barrier diaphragm 4 has a circular shape with an outer diameter of φ10 to 16 mm and a thickness of 0.01 to 0.03 mm.

As mentioned above, the waterproof vibration transducer module 1 according to the present embodiment is configured such that the barrier diaphragm 4 is not adhesively fixed to a case unlike the prior art of Patent Literature 1 but is clamped and fixed by the ribs 32 of the holder 3 and the protrusion portion 22 of the substrate 2. This configuration offers an advantage that manufacturing variation is less likely to occur.

As illustrated in FIG. 4, the first case 5 may be a case having a substantially rectangular parallelepiped shape opened in the −z direction, for example. On the +z side surface of the first case 5, a sound hole 51 is formed.

As illustrated in FIG. 3, it is preferable to form a cover portion 52, which covers the hole 31 when viewed in the stacking direction (z-axis direction), at the sound hole 51. For example, it is more preferable that the cover portion 52 covers 90% or more of the hole 31 when viewed in the stacking direction (z-axis direction).

Alternatively, the cover portion 52 may be described as having the sound hole 51 formed as an annular slit whose center coincides with the center of the hole 31 when viewed in the stacking direction (z-axis direction).

By forming the cover portion 52 or forming the sound hole 51 as an annular slit whose center coincides with the center of the hole 31 when viewed in the stacking direction (z-axis direction), it is possible to prevent jets of water during high-pressure cleaning, for example, from passing through the sound hole 51 and directly hitting the barrier diaphragm 4. This prevents the gap between the holder 3 and the barrier diaphragm 4 from being widened by water pressure and water from entering the space B, thereby improving waterproof performance.

As illustrated in FIG. 5, the sound hole 51 may be formed to penetrate through the first case 5 at an angle different from the stacking direction (+/−z direction) (diagonally downward left and diagonally downward right in the example illustrated in FIG. 5). By forming the sound hole 51 so as to penetrate through the first case 5 at the angle different from the stacking direction (+/−z direction), it is possible to prevent jets of water during high-pressure cleaning, for example, from directly hitting the barrier diaphragm 4.

The second case 6 is combined with the first case 5. As illustrated in FIG. 3, the second case 6 may be a case having a rectangular parallelepiped shape opened in the +z direction, for example. Further, the second case 6 may include a terminal 61, which is electrically connected with the substrate 2, and a cable 62. An end portion of the cable 62 in the −x direction is connected with the terminal 61 and an end portion in the +x direction is connected with the connector 7.

It is preferable that the terminal 61 and the cable 62 are integrally formed with the second case 6. By integrally forming the terminal 61 and the cable 62 with the second case 6, the terminal 61 and the cable 62 are also made waterproof, thereby improving the waterproof performance of the entire module.

As illustrated in FIG. 5, the substrate 2, the holder 3, and the barrier diaphragm 4 are accommodated in an internal space formed by combining the first case 5 and the second case 6 with each other. The internal space is partitioned into two spaces (A and B) by the holder 3 and the barrier diaphragm 4, and the space B on the second case 6 side is sealed, as illustrated in FIG. 5.

The waterproof vibration transducer module 1 according to the present embodiment is applicable to, for example, a sound collecting microphone for which a waterproofing property is required, a sound collecting microphone for which flat frequency characteristics are required across a wide band, a sound collecting microphone for which a high S/N ratio is required, and a sound collecting microphone for which high-pressure cleaning is required.

The foregoing description of the embodiment of the invention has been presented for the purpose of illustration and description. It is not intended to be exhaustive and to limit the invention to the precise form disclosed. Modifications or variations are possible in light of the above teaching. The embodiment was chosen and described to provide the best illustration of the principles of the invention and its practical application, and to enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally, and equitably entitled.

What is claimed is:

1. A waterproof vibration transducer module comprising:
a substrate which includes a through hole, a protrusion portion provided on one surface so as to surround the through hole, and a vibration conversion die mounted on the other surface so as to close the through hole;
a holder which includes a hole and a rib being on a position surrounding the hole;
a barrier diaphragm which is on a position overlapping with the through hole and the hole when viewed in a stacking direction, is clamped by the protrusion portion and the rib, and vibrates in a space formed by the hole and the protrusion portion;
a first case in which a sound hole is formed; and
a second case which is combined with the first case, wherein
the substrate, the holder, and the barrier diaphragm are accommodated in an internal space formed by combining the first case and the second case with each other, the internal space is partitioned into two spaces by the holder and the barrier diaphragm, and one of the two spaces on a second case side is sealed.

2. The waterproof vibration transducer module according to claim 1, wherein
a cover portion is formed at the sound hole, the cover portion covering 90% or more of the hole when viewed in the stacking direction.

3. The waterproof vibration transducer module according to claim 1, wherein
the sound hole is formed as an annular slit whose center coincides with a center of the hole when viewed in the stacking direction.

4. The waterproof vibration transducer module according to claim 2, wherein
the sound hole penetrates through the first case at an angle different from the stacking direction.

5. The waterproof vibration transducer module according to claim 3, wherein
the sound hole penetrates through the first case at an angle different from the stacking direction.

6. The waterproof vibration transducer module according to claim 1, wherein
the second case includes a terminal and a cable, the terminal being electrically connected with the substrate, and
the terminal and the cable are integrally formed with the second case.

7. The waterproof vibration transducer module according to claim 1, wherein
the substrate includes
a notch filter which blocks a predetermined frequency of an output signal from the vibration conversion die, and
an amplifier circuit which adjusts a level of the output signal from the vibration conversion die.

8. The waterproof vibration transducer module according to claim 1, wherein
the protrusion portion has an annular shape with an inner diameter of φ8 to 12 mm and a height of 0.02 to 0.08 mm.

9. The waterproof vibration transducer module according to claim 1, wherein
the barrier diaphragm has a circular shape with an outer diameter of φ10 to 16 mm and a thickness of 0.01 to 0.03 mm.

10. The waterproof vibration transducer module according to claim 1, wherein
the holder exhibits a Shore hardness of D40 to D70.
